(19) United States
(12) Patent Application Publication
(10) Pub. No.: US 2007/0160908 A1
(43) Pub. Date: Jul. 12, 2007

(54) Anode material for secondary battery and secondary batteries using the same

(76) Inventors: Ho-Gun Kim, Seoul (KR); Jong-Sung Kim, Gyeonggi-do (KR); Dong-Hun Shin, Gyeonggi-do (KR); Chul Youm, Gyeonggi-do (KR); Jeong-Hun Oh, Gyeonggi-do (KR)

Correspondence Address: JONES DAY, 222 EAST 41ST ST, NEW YORK, NY, 10017, US

(21) Appl. No.: 11/651,361

(22) Filed: Jan. 8, 2007

(30) Foreign Application Priority Data
Jan. 11, 2006 (KR) 10-2006-0003156
Jan. 11, 2006 (KR) 10-2006-0003157

(51) Int. Cl. H01M 4/58; H01B 1/04

(52) U.S. Cl. 429/231.4; 252/182.1; 252/502

(57) ABSTRACT

Disclosed are an anode material for a secondary battery and a secondary battery using the same. The present invention provides the anode material for a secondary battery, produced by coating a high-crystallinity core carbonaceous material with a coating carbonaceous material and calcining the high-crystallinity core carbonaceous material, wherein the anode material for a secondary battery has a delamination area of 0.1×10⁻⁵ to 1.0×10⁻⁴ or a volume fraction of water uptake of 0.01 or less. The secondary battery according to the present invention may be useful to improve a charging/discharging capacity and a charging/discharging efficiency of the battery and ensure a stability of the battery since the battery has an improved protection against a degradation reaction of an electrolyte if the battery is produced using the anode material for a secondary battery.

### BACKGROUND OF THE INVENTION

1. Field of the Invention

The present invention relates to an anode material for a secondary battery and a secondary battery using the same, and more particularly to an anode material for a secondary battery, produced by coating a high-crystallinity core carbonaceous material with a coating carbonaceous material and calcining the high-crystallinity core carbonaceous material, wherein the anode material for a secondary battery may be used for producing a secondary battery capable of improving a discharging capacity and a charging/discharging efficiency of a battery by adjusting a delamination area or a volume fraction of water uptake, and a secondary battery using the same.

2. Description of the Related Art

Recently, there has been an increasing demand for a small-sized and lightweight secondary battery having a relatively high capacity and this trend has been accelerated as electronic apparatuses using a battery, including a portable phone, a portable notebook computer, an electric vehicle and like, come into wide use.

A high charging/discharging efficiency may be accomplished by a lithium ion secondary battery using a metal lithium as an anode material of the secondary battery. However, the lithium ion secondary battery has a disadvantage that an internal short circuit may be caused since dendrite is formed while depositing a lithium ion into a surface of the metal lithium upon charging. Due to the disadvantage, there has been proposed an alternative technology in which lithium alloys such as a lithium/aluminum alloy are used instead of the lithium metal. However, the lithium alloys have a disadvantage that a stable electrical property is not ensured if an alloy is used for an extended time due to segregation of the alloy caused when charge/discharge cycles are repeated for a long time. Meanwhile, a carbonaceous material having a high degree of carbonization was known as a promising material having an excellent charge/discharge cycle characteristic and a high stability of a battery since the carbonaceous material has a high charging/discharging efficiency, and a small voltage change upon discharging. However, the carbonaceous materials, including materials from graphite to amorphous carbon, have various structures and shapes, and therefore there have been proposed various shapes of carbonaceous materials having different properties according to physical properties or various microstructures of carbon since an electrode performance of the battery depends on the different physical properties and the various microstructures of the carbon.

A lithium anode material for a secondary battery, used in recent years, includes carbon-based materials calcined at approximately 1,000° C., and graphite-based materials calcined at approximately 2,800° C. If the carbon-based materials are used as an anode material, the carbon-based materials have an advantage that an electrolyte is not dissolved due to a low reactivity to the electrolyte, while the carbon-based materials have a disadvantage that their potential changes are increased due to emission of lithium ions. Meanwhile, the graphite-based materials have an advantage that their potential changes are small due to emission of lithium ions, while the carbon-based materials have a disadvantage that they react to an electrolyte to dissolve the electrolyte, which may further destroy the electrode materials. As a result, a charging/discharging efficiency and a cycle characteristic of the battery are deteriorated, and a stability of the battery is damaged.

In an aspect to solve the above-mentioned problems, there has been proposed a method for modifying a surface of a carbonaceous material. Therefore, it was found that the surface-modified carbonaceous material having certain physical properties has an increased battery capacity and an improved cycle characteristics since reaction of the carbonaceous material with the electrolyte is inhibited. Accordingly, there have been attempts to develop a carbonaceous material capable of being used as an anode material of the secondary battery which can ensure an optimal battery characteristic, and the present invention was designed based on the above-mentioned facts.

### SUMMARY OF THE INVENTION

The present invention is designed to solve the problems of the prior art, and therefore it is an object of the present invention to provide an anode material for a secondary battery capable of solving various problems of the carbonaceous material used as the above-mentioned anode material of conventional secondary batteries, for example preventing an electrolyte from being dissolved when the anode material reacts to the electrolyte, and therefore preventing a battery characteristic from being deteriorated by the dissolution of the electrolyte, and a secondary battery using the same.

In order to accomplish the above object, the present invention provides one anode material for a secondary battery, produced by coating a high-crystallinity core carbonaceous material with a coating carbonaceous material and calcining the high-crystallinity core carbonaceous material, wherein the anode material for a secondary battery has a delamination area of 0.1×10⁻⁵ to 1.0×10⁻⁴.

In order to accomplish the above object, the present invention provides another anode material for a secondary battery, produced by coating a high-crystallinity core carbonaceous material with a coating carbonaceous material and calcining the high-crystallinity core carbonaceous material, wherein the anode material for a secondary battery has a volume fraction of water uptake of 0.01 or less.

The coating carbonaceous material preferably has a relatively lower Raman intensity ratio than the core carbonaceous material. The anode material for a secondary battery preferably has a ratio (I₁₃₆₀/I₁₅₈₀) of 0.01 to 0.45, the ratio (I₁₃₆₀/I₁₅₈₀) being a ratio of a peak intensity (I₁₃₆₀) at 1,360 cm⁻¹ to a peak intensity (I₁₅₈₀) at 1,580 cm⁻¹ observed by a Raman spectroscopy analysis using an argon (Ar) laser having a wavelength of 514.5 nm. The anode material for a secondary battery preferably has a tap density of 0.7 g/cm³ or more. The anode material for a secondary battery preferably has a BET specific surface area of 4 m²/g or less. Preferably, the high-crystallinity core carbonaceous material is natural graphite.

In order to accomplish the above object, the present invention provides a secondary battery using the anode material for a secondary battery as a battery anode so as to meet the mentioned-above requirements. At this time, the secondary battery preferable has a discharging capacity of 340 mAh/g or more and a charging/discharging efficiency of 90% or more.

### BRIEF DESCRIPTION OF THE DRAWINGS

Other objects and aspects of the present invention will become apparent from the following description of embodiments with reference to the accompanying drawings. However, it should be understood that the description proposed herein is just a preferable example for the purpose of illustrations only, not intended to limit the scope of the invention. In the drawings:

FIG. 1 is a diagram showing a section of a carbon electrode and an equivalent circuit for the carbon electrode together.

### DESCRIPTION OF THE PREFERRED EMBODIMENT

Hereinafter, preferred embodiments of the present invention will be described in detail referring to the accompanying drawings. However, the description proposed herein is just a preferable example for the purpose of illustrations only, not intended to limit the scope of the invention, so it should be understood that other equivalents and modifications could be made thereto without departing from the spirit and scope of the invention. The preferred embodiments of the present invention will be described in detail for the purpose of better understandings, as apparent to those skilled in the art.

### Embodiments 1 and 2 and Comparative Examples 1 and 2

The carbonaceous materials, classified into Embodiments 1 and 2 and Comparative examples 1 and 2, were used as the anode material, as listed in the following Table 1. Also, a weight ratio of a carbonaceous material to a pitch dissolved in tetrahydrofuran (THF) is determined as listed in the following Table 1. Electrodes were produced according to a method, as described later, using the carbon-mixed materials as listed in following Table 1.

TABLE 1

| | Embodiments | | Comparative examples | |
|---|---|---|---|---|
| | 1 | 2 | 1 | 2 |
| Kind of | Spherical | Spherical | Natural | Natural |
| Carbonaceous Material | Graphite-based | Graphite-based | Graphite-based | Graphite-based |
| | Carbonaceous | Carbonaceous | Carbonaceous | Carbon with less |
| | Material | Material | Material | Spheroidization |
| | | | | Behavior |
| Carbonaceous | 9:1 | 9.5:0.5 | 10:0 | 10:0 |
| Material:Pitch | | | | |
| (Weight Ratio) | | | | |

The mixed materials as listed in Table 1 were homogeneously mixed by means of wet stirring for 2 hours under an ambient pressure. Subsequently, the resultant mixture was sequentially calcined firstly at 1,100° C. for 1 hour and secondly at 1,500° C. for 1 hour. After the two calcination steps, the mixture was distributed to remove fine powder. Subsequently, 100 g of the mixture from which fine powder was removed, was added to a 500 ml vial and kneaded with a small amount of N-methylpyrrolidone (NMP). The kneaded mixture was pressed and attached onto a copper mesh, and then dried to produce an electrode, which may be used for a battery. Finally, a step of producing an electrolyte solution was carried out using, as an electrolyte solution, the mixed solution of ethylene carbonate and diethyl carbonate in which 1 mol/L LiPF₆ was dissolved. At this time, the ethylene carbonate and the diethyl carbonate were adjusted to a volume ratio of 1:1 in the mixed solution of ethylene carbonate and diethyl carbonate.

The mixtures of the pitch and the carbonaceous materials for a secondary battery according to Embodiments 1 and 2 and Comparative examples 1 and 2 were measured for various physical properties, for example, a specific surface area, a tap density, an aspect ratio, a Raman value (a peak intensity and a full width at half maximum of the peak), a battery characteristic (a discharging capacity and a charging/discharging efficiency), etc, as follows. The results are listed in the following Table 2. Meanwhile, a triode battery was made using the produced electrode and the electrolyte solution, and then respectively measured for a delamination area and a volume fraction of water uptake according to a method for measuring an impedance. The results are listed together in the following Table 2.

Measurement of Specific Surface Area

The battery has a high specific surface area if natural graphite is used as a material of a core carbon, and a specific surface area of the battery tends to decrease if microphores of the core carbon are closed due to attachment or coating of the carbon derived from the pitch, etc.

A specific surface area analyzer (Brunauer-Emmett-Teller, hereinafter referred to as “BET”) is an apparatus for measuring a specific surface area of powder, or sizes and a size distribution of pores present in porous mass, and may calculate a surface area and a pore size according to a BET equation, represented by the following Equation 1, by measuring an amount of nitrogen gas adsorbed to a surface and pores of a test material.

$$q = \frac{{V}_{m} {A}_{m} C}{( {C}_{s} - C ) [ 1 + ( {A}_{m} - 1 ) ( C / {C}_{S} ) ]} \qquad Equation 1$$

wherein, “q” represents an amount of adsorbed nitrogen gas;

Vₘ and Aₘ represent constant values, respectively;

“C” represents an equilibrium concentration; and

“Cs” represents a saturation concentration.

Meanwhile, a test material was determined for a specific surface area using an ASAP 2400 specific surface area analyzer (Micromeritics) in the present invention.

An anode material used for the secondary battery preferably has a BET specific surface area of 4 m²/g or less. If the BET specific surface area exceeds 4 m²/g, an available capacity of the secondary battery is decreased due to its increased irreversible capacity.

Measurement of Tap Density

A tap density of a carbonaceous material is related to diameter, shape, surface or the like of a carbonaceous material powder, and therefore the tap density may be varied according to a particle size distribution of the carbonaceous material even if particles of the carbonaceous material have the same mean diameter. Generally, the tap density is increased if the particles are coated, but not increased if a large amount of scale-shaped or fine particles is present. Since the graphite used in the present invention has a high tap density if the particle is ground into powder as fine as possible, an apparent density may be enhanced by facilitating penetration of the electrolyte solution into the pores.

A tap density is referred to as a value obtained by stirring a cell, tapped with a test sample, under a predetermined condition, followed by measuring a density of the sample. In the present invention, the tap density was measured according to a JIS-K5101 method, as follows. Firstly, a powder tester PT-R (Hosokawa Micron) was used herein, and a particle size of a test sample was adjusted with a sieve having a scale interval of 200 μm. A 20 cc tapping cell was fully filled with a test sample, graphite powder, by dropping the graphite powder into the cell, and the tapping cell was tapped 3,000 times with a tapping distance of 18 mm while applying a tapping vibration once per second, and then a tap density was measured. Meanwhile, the anode material used for the secondary battery has a reduced capacity if it has a tap density of 0.7 g/cm³ or less.

Measurement of Aspect Ratio

An aspect ratio is generally referred to as a ratio of a length to a width of a rectangular structure, but a ratio of the longest axial diameter to the shortest axial diameter of a subject to be measured, for example a graphite particle, is measured as the aspect ratio in the present invention, considering that the subject to be measured is composed of particles. It is noted that, since the subject to be measured is composed of particles, the particles of the subject to be measured are physically close to a spherical shape as the aspect ratio approaches a value of 1. It is also known that the particles are nearly close to an oval shape if the value is relatively greater than 1, and close to a rod shape if the value is excessively high. The graphite particle used as the carbonaceous material for a secondary battery preferably has an improved tapping efficiency as its aspect ratio approaches a value of 1. The aspect ratio according to the present invention was determined by observing graphite particles (powders) with 3,000 magnifications using a scanning electron microscope (SEM, Model No: S-2500, Hitachi Seisakusho) and randomly selecting 50 graphite particles out of the graphite particles, followed by measuring ratios of the longest diameters to the shortest diameters of the selected graphite particles to calculate an average of the measured ratios.

Raman Spectrum Analysis (Measurement of Peak Intensity Ratio and Full Width at Half Maximum)

A Raman spectrum is used for analyzing a microstructure of carbon that forms an outer layer, and a peak intensity (I₁₅₈₀) at 1,580 cm⁻¹ represents a peak intensity corresponding to a crystal structure of the carbon having a high crystallinity, and a peak intensity (I₁₃₆₀) at 1,360 cm⁻¹ represents a peak intensity corresponding to a crystal structure of the carbon having a low crystallinity. Generally, a charging/discharging efficiency is preferably improved if a peak intensity ratio, namely a value of I₁₃₆₀/I₁₅₈₀, ranges from 0.01 to 0.45. Meanwhile, a peak at 1,580 cm⁻¹ of the Raman spectrum is varied according to the integrity of a crystalline region, and its full width at half maximum becomes narrower as a highly ordered structure of carbon becomes distributed uniformly. The full width at half maximum is used for analyzing characteristics of carbon, and preferably ranges from 16 to 35. If the full width at half maximum is out of the range, a capacity of the secondary battery is reduced due to the ununiform arrangement of the crystal structure.

Two peaks, namely a peak intensity (I₁₃₆₀) at 1,360 cm⁻¹ and a peak intensity (I₁₅₈₀) at 1,580 cm⁻¹, which are observed by a Raman spectroscopy analysis using an argon (Ar) laser having a wavelength of 514.5 nm, were measured respectively, and then their relative peak intensity ratio (R) was calculated using the following Equation 2. Meanwhile, the full width at half maximum was measured using a peak fitting program.

$$R = \frac{{I}_{1360}}{{I}_{1580}} \qquad Equation 2$$

Measurement of Delamination Area

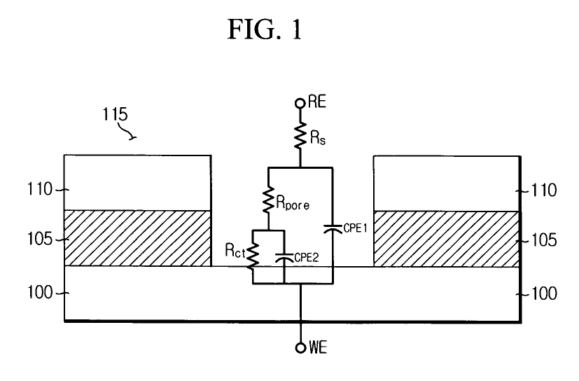

The delamination area was measured using an IM6e Potentiostat (Zahner). An impedance was measured at a frequency range of 10 kHz to 10 MHz with a standard error of ±5 mV. An equivalent circuit was configured using a THALES fitting program (see FIG. 1), and then a quantitative value was calculated. A delamination area of the coating was calculated from the calculated values of Rₚₒᵣₑ (resistance between an electrode interface and an electrolyte solution) and C_{coat} (coating capacitance). If the delamination area ranges from 0.1×10⁻⁵ to 1.0×10⁻⁴, the protection against a degradation reaction of the electrolyte may be improved, and therefore charging/discharging capacity and efficiency of the battery may be enhanced.

Meanwhile, the values, obtained from the test results, may be somewhat different to a theoretical value due to the ununiformity in the electrode interface. The values C_{coat} and C_{dl} (capacitance between an electrode interface and a copper foil layer) were substituted with CPE1 and CPE2, respectively, while configuring an equivalent circuit as shown in FIG. 1, which is revised by introducing a constant phase element (CPE, so-called used in place of capacitance) in a fitting process. A delamination area (A_{d}) was calculated using the following Equations 3 and 4.

R^{o}ₚₒᵣₑ=ρ×d(ohm·cm²) Equation 3

A_{d}=R^{o}ₚₒᵣₑ/Rₚₒᵣₑ Equation 4

wherein, R^{o}ₚₒᵣₑ represents a resistance value between an initial electrode interface and an electrolyte solution;

Rₚₒᵣₑ represents a resistance value between an electrode interface and an electrolyte solution according to time changes;

“ρ” represents a thickness of an electrode interface; and

“d” represents a specific resistance of an electrode interface.

Measurement of Volume Fraction of Water Uptake (V)

The volume fraction of water uptake was measured using an IM6e Potentiostat (Zahner). An impedance was measured at a frequency range of 10 kHz to 10 MHz with a standard error of ±5 mV. An equivalent circuit was configured using a THALES fitting program, and then a quantitative value was calculated. The volume fraction of water uptake was calculated from the quantitative C_{coat} values using the following Equation 5.

$$V = log [ \frac{{C}_{coat} ( t )}{{C}_{coat} ( 0 )} ] / log 8 \; 0 \qquad Equation 5$$

wherein, C_{coat} (t) represents a capacitance value of the coating according to time changes; and

C_{coat} (0) represents an initial capacitance value of the coating.

Meanwhile, the values, obtained from the test results, may be somewhat different to a theoretical value due to the ununiformity in the electrode interface. Accordingly, the values were revised by introducing a constant phase element (CPE, so-called used in place of capacitance) in a fitting process, and then substituting the C_{coat} and C_{dl}, calculated from the following Equation 5, with CPE1 and CPE2, respectively, while configuring an equivalent circuit as shown in FIG. 1.

FIG. 1 is a diagram showing a section of a carbon electrode and an equivalent circuit for the carbon electrode together.

Referring to FIG. 1, a graphite layer 105 which is a carbonaceous material, and a solid electrolyte interface (SEI) layer 110 were exposed to an electrolyte layer 115, the graphite layer 105 and the SEI layer 110 being sequentially laminated on a copper foil layer 100. An equivalent circuit corresponding to the battery structure was illustrated to correspond to the resistances connected in series/parallel, for example Rₛ (a resistance of an electrolyte solution), Rₚₒᵣₑ (a resistance between an electrode interface and an electrolyte) and R_{ct} (a resistance between an electrode interface and a copper foil layer), and the capacitors, namely CPE1 (a capacitance of an electrolyte and an electrode layer) and CPE2 (a capacitance of an electrode layer and a copper foil), respectively. The equivalent circuit may be configured to exhibit electrochemical characteristics, and a battery performance may be measured using electrochemical characteristic factors, for example Rₛ, Rₚₒᵣₑ, R_{ct}, CPE1 and CPE2.

Meanwhile, an protective function against a degradation reaction of the electrolyte is improved if a delamination area ranges from 0.1×10⁻⁵ to 1.0×10⁻⁴, or if a volume fraction of water uptake is 0.01 or less, and therefore a charging/discharging capacity and a charging/discharging efficiency are preferably improved.

Measurement of Battery Characteristics (Discharging Capacity and Charging/Discharging Efficiency)

A charge/discharge test of the spherical graphite-based carbonaceous material, coated with the pitch, was carried out with limiting an electric potential to a range of 0 to 1.5 V, that is, a secondary battery was charged with a charging current of 0.5 mA/cm² to a voltage of 0.01 V, and then continued to be charged to a charging current of 0.02 mA/cm² while maintaining the voltage of 0.01 V. And, the secondary battery was then discharged with a discharging current of 0.5 mA/cm² to a voltage of 1.5 V. In the following Table 2, the charging/discharging efficiency represents a ratio of a discharged electrical capacity to a charged electrical capacity. Meanwhile, the secondary battery preferably has a discharging capacity of 340 mAh/g or more and a charging/discharging efficiency of 90% or more.

TABLE 2

| | Embodiments | | Comparative examples | |
|---|---|---|---|---|
| | 1 | 2 | 1 | 2 |
| Specific Surface Area (m²/g) | 1.6 | 1.8 | 7.5 | 8.7 |
| Tap Density (g/cm³) | 1.14 | 1.05 | 0.92 | 0.76 |
| Aspect Ratio | 1.432 | 1.497 | 1.728 | 1.998 |
| Raman Intensity Ratio | 0.41 | 0.40 | 0.09 | 0.08 |
| Full Width at Half Maximum | 32.6 | 31.2 | 14.2 | 14.1 |
| Delamination Area (×10⁻⁴) | 0.2898 | 0.7233 | 2.5477 | 2.7244 |
| Volume Fraction of Water Uptake | 0.00238 | 0.00351 | 0.03280 | 0.03303 |
| Discharging Capacity (mAh/g) | 348.2 | 342.5 | 330.4 | 321.7 |
| Charging/Discharging Efficiency (%) | 94.2 | 94.5 | 81.2 | 77.4 |

As seen in Table 2, it was revealed that all of the measured values of the physical properties are more excellent in Embodiments 1 and 2 than in Comparative examples 1 and 2. In particular, it was seen that the secondary battery of the Embodiments 1 and 2 has a delamination area of 1.0×10⁻⁴ or less and a volume fraction of water uptake of less than 0.01. From the measured values of the delamination area and the volume fraction of water uptake, the protective function against a degradation reaction of an electrolyte is improved, and therefore the charging/discharging capacity and the charging/discharging efficiency of the battery are improved.

As described above, the best embodiments of the present invention are disclosed. Therefore, the specific terms are used in the specification and appended claims, but it should be understood that the description proposed herein is just a preferable example for the purpose of illustrations only, not intended to limit the scope of the invention.

### APPLICABILITY TO THE INDUSTRY

As described abode, it was revealed that the anode material for a secondary battery according to the present invention is produced by coating a high-crystallinity core carbonaceous material with a coating carbonaceous material, followed by undergoing a predetermined calcination process, and the produced anode material has better delamination area and volume fraction of water uptake than conventional anode materials. The protection against a degradation reaction of an electrolyte can be improved, and therefore the charging/discharging capacity and the charging/discharging efficiency can be improved and the stability may also be ensured if a battery is produced using the anode material for a secondary battery having such a physical property.

What is claimed is:

1. An anode material for a secondary battery, produced by coating a high-crystallinity core carbonaceous material with a coating carbonaceous material and calcining the high-crystallinity core carbonaceous material, wherein the anode material for a secondary battery has a delamination area of 0.1×10⁻⁵ to 1.0×10⁻⁴.

2. The anode material for a secondary battery according to claim 1,
wherein the coating carbonaceous material has a relatively lower Raman intensity ratio than the core carbonaceous material.

3. The anode material for a secondary battery according to claim 1,
wherein the anode material for a secondary battery has a ratio (I₁₃₆₀/I₁₅₈₀) of 0.01 to 0.45, the ratio (I₁₃₆₀/I₁₅₈₀) being a ratio of a peak intensity (I₁₃₆₀) at 1,360 cm⁻¹ to a peak intensity (I₁₅₈₀) at 1,580 cm⁻¹ observed by a Raman spectroscopy analysis using an argon (Ar) laser having a wavelength of 514.5 nm.

4. The anode material for a secondary battery according to claim 1,
wherein the anode material for a secondary battery has a tap density of 0.7 g/cm³ or more.

5. The anode material for a secondary battery according to claim 1,
wherein the anode material for a secondary battery has a BET specific surface area of 4 m²/g or less.

6. The anode material for a secondary battery according to claim 1,
wherein the high-crystallinity core carbonaceous material is natural graphite.

7. A secondary battery produced using, as a battery anode, the anode material for a secondary battery as defined in any of claims 1 to 6.

8. The secondary battery according to claim 7,
wherein the secondary battery has a discharging capacity of 340 mAh/g or more and a charging/discharging efficiency of 90% or more.

9. An anode material for a secondary battery, produced by coating a high-crystallinity core carbonaceous material with a coating carbonaceous material and calcining the high-crystallinity core carbonaceous material,
wherein the anode material for a secondary battery has a volume fraction of water uptake of 0.01 or less.

10. The anode material for a secondary battery according to claim 9,
wherein the coating carbonaceous material has a relatively lower Raman intensity ratio than the core carbonaceous material.

11. The anode material for a secondary battery according to claim 9,
wherein the anode material for a secondary battery has a ratio (I₁₃₆₀/I₁₅₈₀) of 0.01 to 0.45, the ratio (I₁₃₆₀/I₁₅₈₀) being a ratio of a peak intensity (I₁₃₆₀) at 1,360 cm⁻¹ to a peak intensity (I₁₅₈₀) at 1,580 cm⁻¹ observed by a Raman spectroscopy analysis using an argon (Ar) laser having a wavelength of 514.5 nm.

12. The anode material for a secondary battery according to claim 9,
wherein the anode material for a secondary battery has a tap density of 0.7 g/cm³ or more.

13. The anode material for a secondary battery according to claim 9,
wherein the anode material for a secondary battery has a BET specific surface area of 4 m²/g or less.

14. The anode material for a secondary battery according to claim 9,
wherein the high-crystallinity core carbonaceous material is natural graphite.

15. A secondary battery produced using, as a battery anode, the anode material for a secondary battery as defined in any of claims 9 to 14.

16. The secondary battery according to claim 15,
wherein the secondary battery has a discharging capacity of 340 mAh/g or more and a charging/discharging efficiency of 90% or more.
